(19) United States
(12) Patent Application Publication
(10) Pub. No.: US 2025/0182158 A1
(43) Pub. Date: Jun. 5, 2025

(54) METHOD AND SYSTEM OF INITIATING AN ACTION BASED ON AN ATTENTION CATEGORY

(71) Applicant: InMobi Pte Ltd., Singapore (SG)

(72) Inventors: Monit Goyal, Bengaluru (IN); Ian Anderson, Monmouthshire (GB); Bharat Bhagat, Bengaluru (IN)

(73) Assignee: InMobi Pte Ltd., Singapore (SG)

(21) Appl. No.: 18/960,245

(22) Filed: Nov. 26, 2024

(30) Foreign Application Priority Data
Dec. 1, 2023 (IN) 202311081886

(51) Int. Cl. G06Q 30/0242; G01D 21/02

(52) U.S. Cl. CPC G06Q 30/0242; G01D 21/02

(57) ABSTRACT

A method and a system of initiating an action based on an attention category is disclosed. The method encompasses: 1) receiving, at a transceiver unit [102], a sensor data from one or more sensors configured on a user device, wherein the sensor data is received in an event a content is provided on the user device; 2) analyzing, by a processing unit [104], the sensor data; 3) predicting in real-time, by the processing unit [104], an attention score for a user of the user device based on the analyzed sensor data, wherein the attention score indicates a probability of the user paying attention to the content; 4) categorizing, by a categorization unit [106], the attention score in an attention category based on a pre-defined attention threshold; and 5) initiating, by the processing unit [104], an action based on the attention category.

### CROSS REFERENCE TO RELATED APPLICATION

This application claims the benefit under 35 U.S.C. §§ 119 and 365 to Indian Patent Application No. 202311081886, filed Dec. 1, 2023, the entire contents of which are incorporated herein by reference.

### TECHNICAL FIELD

The present disclosure generally relates to the field of data analysis and data processing. More particularly, the present disclosure relates to a method and a system of initiating an action on a user device based on an attention category, wherein the attention category is determined based on an attention score indicating a user's attention for a content displayed on the user device.

### BACKGROUND OF THE DISCLOSURE

The following description of the related art is intended to provide background information pertaining to the field of the disclosure. This section may include certain aspects of the art that may be related to various features of the present disclosure. However, it should be appreciated that this section is used only to enhance the understanding of the reader with respect to the present disclosure, and not as admissions of the prior art.

Over the past few years, the advancement in digital technologies has improved the content delivery on smart devices. Content delivery on smart devices refers to the process of distributing various forms of digital content, such as videos, audios, games, e-books, and more, to smart devices such as smartphones, tablets, smart TVs, and other such devices. Also, an advertisement (Ad) is such a digital content that is served to users of such smart devices. Moreover, to serve an Ad to a user of a smart device following entities may participate in the process of serving the Ad:
A Publisher that has a digital space where the Ad is shown.
An Advertiser that wishes to show their Advert to a specific audience e.g., women living and working in Bangalore, India.
The user that has an application (app) installed in the smart device with their own user profile and associated demographic data e.g., news app with user profile—Male, Student, living in Mexico.
A third-party tracker service to validate and verify the user's interactions with the Advert were genuine and fulfilled a targeting criterion.
Ad tech platform that is responsible for matching Advertisers to Users, monetising publisher digital spaces and coordinating with third-party tracking and analytics platforms.

Also, generally a workflow of showing an Advert to a user goes through the following:
1. The user starts to interact with their device with a request for an Ad sent to the Ad tech platform.
2. The Ad tech platform searches the list of available Adverts from the Advertisers with campaigns in current operation.
3. The most appropriate Ad is sent to the user's device.
4. Ad is displayed.
5. The user may or may not pay attention.
6. The user may or may not interact.
7. Interactions are (in some cases) verified by the third-party tracking software.

It is important to note that Advertisers running a campaign agree the pricing and behavior that they wish to operate their campaign with the Ad Technology Platform. It is the responsibility of the Ad Technology Platform to deliver against these criteria. For example, an Advertiser may specify an overall budget for the campaign, a fee per Ad impression, a targeting criterion, and Ad impression delivery constraints etc. The current solutions in content delivery such as in advertising face several unmet needs and challenges that impact advertisers, publishers, and audiences. One of the key problems is the lack of reliable metrics to determine if users have truly paid attention to the content, e.g., the advertisement, as opposed to merely being exposed to it. Also, in the existing arts, there is a lack of consensus regarding viewability standards and despite efforts to reconcile viewability measurements, significant reporting discrepancies persist between different viewability providers, leading to inconsistencies in reported data. Moreover, Advertisers suffer substantial financial losses due to widespread Ad fraud, which undermines the effectiveness of their campaigns. Third-party verification helps identify fraudulent impressions, but challenges remain. Additionally, a significant portion of publisher inventory cannot be accurately measured, resulting in viewable impressions going uncounted due to technical limitations and adoption issues.

Furthermore, audiences have become adept at ignoring contents such as Ads that are predictably placed, reducing the impact of campaigns. For instance, users anticipate Ads after completing certain stages of a game, leading to decreased attention and engagement. Moreover, in the face of increasing privacy concerns and the removal of traditional tracking methods like third-party cookies and mobile identifiers, content providers such as advertisers seek powerful yet privacy-compliant signals to track campaign performance and audience engagement accurately. Traditional viewability metrics only measure if an Ad was partially visible, failing to capture whether users actually paid attention to it. As user attention is a limited and valuable resource, content providers such as the advertisers strive to ensure their messaging is in front of a target audience for maximum impact.

To measure the engagement of users of smart devices with media contents (e.g., advertisements etc.), several solutions are developed over a period of time. For instance, some solutions provide direct eye-tracking of users to address this requirement, however it presents challenges in terms of privacy and scalability. Moreover, eyeball tracking solutions utilize specialized hardware, such as eye-tracking cameras or goggles, to track users' eye movements and gaze patterns. Additionally, panel-based approaches involve recruiting a specific group of participants who wear eye-tracking equipment while engaging with content such as advertisements. These methods require controlled environments, expensive equipment, and limited sample sizes, making them impractical for widespread implementation.

Furthermore, many existing solutions rely on analyzing user interactions within an app, such as clicks, taps, and dwell time, to infer the level of attention given to a content e.g., an Ad. These approaches consider actions like video play, engagement with interactive elements, or completion of certain tasks as indicators of attention of user for the content. While useful, these metrics are indirect measures of attention and may not accurately reflect users' true engagement.

Therefore, there are a number of limitations of the exiting solutions of measuring engagement of the users of the smart devices with media contents. The present disclosure aims to address the above stated and the other such limitations of existing art.

### OBJECTS OF THE DISCLOSURE

Some of the objects of the present disclosure, which at least one embodiment disclosed herein satisfies are listed herein below.

It is an object of the present disclosure to provide a system and a method that can overcome the limitations of the existing solutions of measuring engagement of the users of the smart devices with media contents such as Ads displayed on the smart devices.

It is another object of the present disclosure to provide a solution that can initiate an action on a user device based on an attention category, wherein the attention category is determined based on an attention score for a user of the user device indicating a probability of the user paying attention to a content provided on the user device.

It is also an object of the present disclosure to provide a solution that can predict a probability of a user paying attention to a content provided on the user device, using a sensor data collected from one or more sensors configured at the user device.

It is another object of the present disclosure to provide a solution that encompasses leveraging device sensors and implementing sophisticated techniques, to provide a reliable and privacy-conscious approach to measure user attention.

It is also an object of the present disclosure to provide a solution that encompasses use of sensors configured on a user device to 1) enable real-time monitoring of user attention to a media content displayed on the user device, and 2) reduce cost by eliminating a need for expensive equipment and extensive recruitment efforts associated with panel-based approaches for real-time monitoring of the user attention to the media content.

It is another object of the present disclosure to provide a solution that may be implemented within various in-application (i.e., in-app) environments, covering a wide range of applications and industries.

Yet another object of the present disclosure is to provide a scalable solution that can be integrated into various devices or that may be compatible with various operating systems, allowing content providers such as advertisers to obtain accurate attention metrics without compromising user privacy.

### SUMMARY OF THE DISCLOSURE

This section is provided to introduce certain aspects of the present disclosure in a simplified form that are further described below in the detailed description. This summary is not intended to identify the key features or the scope of the claimed subject matter.

In order to achieve the aforementioned objectives, one aspect of the disclosure relates to a method for initiating an action based on an attention category. The method encompasses: 1) receiving, at a transceiver unit, a sensor data from one or more sensors configured on a user device, wherein the sensor data is received in an event a content is provided on the user device; 2) analyzing, by a processing unit connected to the transceiver unit, the sensor data; 3) predicting in real-time, by the processing unit, an attention score for a user of the user device based on the analyzed sensor data, wherein the attention score indicates a probability of the user paying attention to the content; 4) categorizing, by a categorization unit connected to the processing unit, the attention score in an attention category based on a pre-defined attention threshold; and 5) initiating, by the processing unit, an action based on the attention category.

Another aspect of the present disclosure relates to a system for initiating an action based on an attention category. The system comprises a transceiver unit, configured to receive, a sensor data from one or more sensors configured on a user device, wherein the sensor data is received in an event a content is provided on the user device. The system further comprises a processing unit connected to the transceiver unit, wherein the processing unit is configured to analyze, the sensor data and predict in real-time, an attention score for a user of the user device based on the analyzed sensor data, wherein the attention score indicates a probability of the user paying attention to the content. The system also comprises a categorization unit connected to the processing unit, wherein the categorization unit is configured to categorize the attention score in an attention category based on a pre-defined attention threshold, and wherein the processing unit is further configured to initiate an action based on the attention category.

### BRIEF DESCRIPTION OF DRAWINGS

The accompanying drawings, which are incorporated herein, and constitute a part of this disclosure, illustrate exemplary embodiments of the disclosed methods and systems in which like reference numerals refer to the same parts throughout the different drawings. Components in the drawings are not necessarily to scale, emphasis instead being placed upon clearly illustrating the principles of the present disclosure. Some drawings may indicate the components using block diagrams and may not represent the internal circuitry of each component. It will be appreciated by those skilled in the art that disclosure of such drawings includes disclosure of electrical components, electronic components or circuitry commonly used to implement such components.

FIG. 1 illustrates an exemplary block diagram of a system [100], for initiating an action based on an attention category, in accordance with exemplary embodiments of the present disclosure.

FIG. 2 illustrates an exemplary method flow diagram [200], for initiating an action based on an attention category, in accordance with exemplary embodiments of the present disclosure.

The foregoing shall be more apparent from the following more detailed description of the disclosure.

### DETAILED DESCRIPTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address any of the problems discussed above or might address only some of the problems discussed above.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

Specific details are given in the following description to provide a thorough understanding of the embodiments. However, it will be understood by one of ordinary skill in the art that the embodiments may be practiced without these specific details. For example, circuits, systems, processes, and other components may be shown as components in block diagram form in order not to obscure the embodiments in unnecessary detail.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

As used herein, a “processing unit” or “processor” or “operating processor” includes one or more processors, wherein processor refers to any logic circuitry for processing instructions. A processor may be a general-purpose processor, a special purpose processor, a conventional processor, a digital signal processor, a plurality of microprocessors, one or more microprocessors in association with a DSP core, a controller, a microcontroller, Application Specific Integrated Circuits, Field Programmable Gate Array circuits, any other type of integrated circuits, etc. The processor may perform signal coding, data processing, input/output processing, and/or any other functionality that enables the working of the system according to the present disclosure. More specifically, the processor or processing unit is a hardware processor.

As used herein, “a user equipment”, “a user device”, “a smart-user-device”, “a smart-device”, “an electronic device”, “a device”, “a mobile device”, “a smart electronic device”, “a handheld device”, “a wireless communication device”, “a mobile communication device”, “a communication device” may be any electrical, electronic and/or computing device or equipment, capable of implementing the features of the present disclosure and these terms may be used interchangeably in this patent specification. The user equipment/device may include, but is not limited to, a mobile phone, smart phone, laptop, a general-purpose computer, desktop, personal digital assistant, tablet computer, wearable device or any other computing device which is capable of implementing the features of the present disclosure. Also, the user device may contain at least one input means configured to receive an input from at least one of a transceiver unit, a processing unit, a storage unit, a categorization unit and any other such unit(s) which are required to implement the features of the present disclosure.

As used herein, “storage unit” or “memory unit” refers to a machine or computer-readable medium including any mechanism for storing information in a form readable by a computer or similar machine. For example, a computer-readable medium includes read-only memory (“ROM”), random access memory (“RAM”), magnetic disk storage media, optical storage media, flash memory devices or other types of machine-accessible storage media. The storage unit stores at least the data that may be required by one or more units of the system to perform their respective functions.

As used herein, “similar” and “same” may be used interchangeably in this patent specification and may convey the same meaning. The use of these terms may not be interpreted as implying any difference in meaning or scope.

As discussed in the background section, the current known solutions have several shortcomings. The present disclosure aims to overcome the above-mentioned and other existing problems in this field of technology by providing a method and a system of initiating an action based on an attention category, wherein the attention category is determined based on an attention score predicted for a user of a user device to indicate a probability of the user paying attention to a content provided on the user device. Particularly, the present disclosure provides a more robust and privacy-compliant solution for measuring user attention in real-time. The solution as disclosed in the present disclosure encompasses capturing valuable attention data using various sensors equipped in a user device thereby eliminating the need for specialized hardware or relying solely on indirect behavioral indicators for attention data collection. Also, the solution encompasses use of tremble data collected from sensors configured on the user device to predict the attention score for the user of the user device. For instance, if the tremble data indicates greater movement, a lower attention score may be predicted or in case the user device is left on a desk there will be no tremble movement, and this may also correlate with the lower attention score.

Particularly, to capture the attention data and generate an attention score, the solution as disclosed in the present disclosure utilizes various device sensors (i.e., the sensors configured at the user device), including but not limited to an accelerometer, a gyroscope, a proximity sensor, an orientation/rotation vector sensor, and/or an audio controls integration sensor. Once the attention data i.e., sensor data is collected, the solution encompasses analyzing and processing the sensor data to generate the attention score as an output, categorizing the level of attention into Very High, High, Medium, Low, or Very Low categories. Further based on the category of the level of attention one or more actions are initiated on the user device, in an e.g., an action may be delivering a specific content such as a specific advertisement on the user device, or in another e.g., an action may be providing a notification or recommendation of a specific content such as a specific media stream on the user device.

Therefore, the present disclosure provides a solution that incorporates a combination of sensors, including accelerometer, gyroscope, proximity sensor, orientation/rotation vector sensor, and/or audio control sensor etc., to capture a comprehensive range of data for attention assessment. This approach is technically advanced over the existing approaches as it leverages multiple sensors to provide a more accurate prediction of user attention. Also, the attention score generated by the solution as disclosed herein introduces a technical advanced classification system that categorizes attention levels of user(s) into different tiers. This scoring framework allows for a more nuanced understanding of user attention based on the collected sensor data. Additionally, the solution as disclosed herein employs multilevel checks to evaluate user attention. It considers various scenarios related to the user device, such as user device orientation, user device movement, proximity changes, and audio level adjustments, to provide a comprehensive assessment of attention. Moreover, the present solution is technically advanced over the existing solutions as it encompasses use of sensors configured on the user device to 1) enable real-time monitoring of user attention to a media content displayed on the user device, and 2) reduce cost by eliminating a need for expensive equipment and extensive recruitment efforts associated with panel-based approaches for real-time monitoring of the user attention to the media content. Additionally, the present solution may be implemented within various in-application (i.e., in-app) environments installed in various devices compatible with different operating systems, covering a wide range of applications and industries. Therefore, the solution as disclosed herein has several technical advantages over the existing solutions.

Hereinafter, exemplary embodiments of the present disclosure will be described in detail with reference to the accompanying drawings so that those skilled in the art can easily carry out the solution provided by the present disclosure.

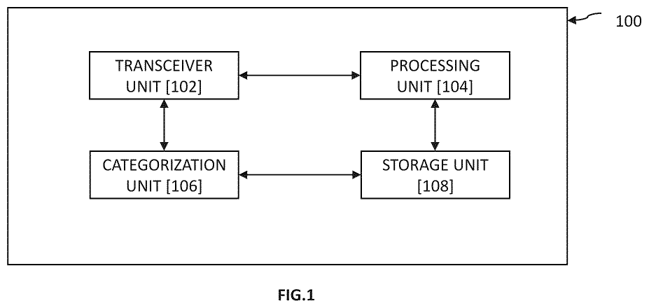

Referring to FIG. 1, an exemplary block diagram of a system [100], for initiating an action based on an attention category is shown, in accordance with exemplary embodiments of the present disclosure. The system [100] comprises at least one transceiver unit [102], at least one processing unit [104], at least one categorization unit [106] and at least one storage unit [108]. Also, all of the components/units of the system [100] are assumed to be connected to each other unless otherwise indicated below. Also, in FIG. 1 only a few units are shown, however, the system [100] may comprise multiple such units or the system [100] may comprise any such numbers of said units, as required to implement the features of the present disclosure. Further, in an implementation, the system [100] may be present in a user device to implement the features of the present disclosure. The system [100] may be a part of the user device/or may be independent but in communication with the user device. In another implementation, the system [100] may be in connection with or may be residing in a server device that is in connection with the user device. In yet another implementation, the system [100] may reside partly in the server device and partly in the user device, in a manner as obvious to a person skilled in the art in light of the present disclosure, to implement the features of the present disclosure.

The system [100] is configured for initiating an action based on an attention category, with the help of the interconnection between the components/units of the system [100].

More specifically, in order to implement the features of the present disclosure, the transceiver unit [202] is configured to receive, a sensor data from one or more sensors configured on the user device, wherein the sensor data is received in an event a content is provided on the user device. Also, in an implementation of the present disclosure the sensor data is received in accordance with one or more pre-defined permissions of data collection and the sensor data is a data that may be correlated with an attention of a user of the user device with the content provided on the user device.

The content is one of an advertisement related media content and a non-advertisement related media content. In a preferred implementation of the present disclosure the content is the advertisement related media content, however the disclosure is not limited thereto, and the features of the present disclosure may also be implemented for non-advertisement related media content for instance at least to predict a user engagement with such non-advertisement related media content.

Further, the one or more sensors may include but not limited to at least one of an accelerometer, a gyroscope, a proximity sensor, an orientation sensor, and an audio control integration sensor etc. Also, the sensor data comprises at least one of an accelerometer sensor data, a gyroscope sensor data, a proximity sensor data, an orientation sensor data, an integration sensor data, and the like data. The accelerometer sensor data is received from the accelerometer, wherein the accelerometer sensor data indicates one or more changes in at least one of a movement of the user device and an acceleration of the user device. The gyroscope sensor data is received from the gyroscope, wherein the gyroscope sensor data indicates one or more changes in at least one of an orientation of the user device and an angular speed of the user device. The proximity sensor data is received from the proximity sensor, wherein the proximity sensor data indicates one or more changes in a distance of the user device from one or more objects (such as for e.g., face of the user etc.). The orientation sensor data is received from the orientation sensor, wherein the orientation sensor data indicates one or more changes in at least one of an orientation of the user device and a direction of the user device. Also, the integration sensor data is received from the audio control integration sensor, wherein the integration sensor data indicates one or more changes in an audio level of the user device. The sensor data helps in considering various scenarios related to the user device, such as including but not limited to user device orientation, user device movement, proximity changes, and audio level adjustments, to provide a comprehensive assessment of user attention for the content.

It is pertinent to note that in the present disclosure although specific details of sensors and sensor data are disclosed, however for implementation of present solution sensor configuration and sensor integration are not limited or restricted in any manner. Any sensor configuration and any sensor integration that may be obvious to a person skilled in the art in light of the present disclosure may be implemented to provide the solution as disclosed in the present disclosure. Mainly, specific types and configurations of sensors utilized in the present disclosure may be altered based on a desired use-case, application, or platform. For example, alternative motion sensors, orientation sensors, proximity sensors, or audio sensors etc., may be used depending on capabilities of various devices or specific attention parameters to be measured. In an implementation, the number of sensors and arrangement of the sensors may also be modified to suit different devices or to optimize data collection. Moreover, the way in which the sensors are integrated into an in-app environment may be adapted to accommodate various user interfaces and operating systems. In an implementation different methods of sensor integration, such as including but not limiting to software development kits (SDKs), application programming interfaces (APIs), or platform-specific frameworks, may be employed to ensure seamless integration and compatibility of the sensors.

Once the sensor data is received, then the processing unit [104] connected to the transceiver unit [102] is configured to analyze the sensor data. The sensor data is analyzed by the processing unit [104] using one or more data analysis techniques that may be obvious to a person skilled in the art for implementation of the features of the present disclosure. Also, in an implementation the processing unit [104] is also configured to pre-process the sensor data using one or more data processing techniques that may be obvious to a person skilled in the art for implementation of the features of the present disclosure. The sensor data may be pre-processed prior to analyzing, in order to remove any ambiguity and/or to convert the sensor data in a required format. Also, in an exemplary implementation during the analysis of the sensor data a weightage may be provided to at least one of the accelerometer sensor data, the gyroscope sensor data, the proximity sensor data, the orientation sensor data, the integration sensor data, and the like data, wherein such weightage may be provided basis a particular use case and may vary in different use cases, for example when a user is holding a user device and watching a content on the user device while walking, more weightage to motion sensor data may be provided as compared to other sensor data, however the disclosure is not limited thereto.

Further, the processing unit [104] is configured to predict in real-time an attention score for a user of the user device based on the analyzed sensor data, wherein the attention score indicates a probability of the user paying attention to the content. Particularly, the attention score indicates a probability of the user paying attention in real-time to one of the advertisement related media content and the non-advertisement related media content. Also, in the preferred implementation of the present disclosure, the attention score indicates the probability of the user paying attention to the advertisement related media content.

Also, the attention score for the user is predicted by the processing unit [104] using one or more temporal probabilistic techniques. In an implementation, a temporal probabilistic technique is a Hidden Markov Technique (HMT) that provides an approach to include the sequence of prior observations (e.g., motion sensor measurements), in the process of inferring a hidden state—i.e., user's attention state (the user's attention is not directly observable).

The HMT (λ) uses three sets of probabilities, the starting state (π), the probability of transitioning from one state to another (A) and the probability of an observation (data measurement) occurring in an Attention State (B).

λ=(A,B,π)

The State Alphabet is:

S=(S_{Full attention},S_{High Attention},S_{Medium Attention},S_{Low Attention},S_{N}_{ₒ}ₐₜₜₑₙₜᵢₒₙ)

The State Alphabet may be extended to support a richer set of attention states. A is the probability of transitioning from one attention state to another (transition matrix). B is the observation matrix that captures the probability of a set of measurements V(1, 2, . . . , v) occurring in a given Attention State. Measurements from the sensors are mapped to a discrete set of observations. For example, an orientation of the user device as indicated by combining sensor data received from the accelerometer and gyroscope. Also, a tremble data (e.g., from the motion sensors) may be processed to represent different states of tremble (motionless Vs slight tremble Vs significant tremble). Using this set of observations V, the probability may be calculated that they occurred in the HMT using the Forward-Backward Technique. This allows to determine an Attention Score/State. In an implementation a previously predicted attention score may be used as feedback to determine an attention score in a particular use case.

In an implementation of the present disclosure, specific techniques and methodologies used for processing and analysing the sensor data may be varied to enhance accuracy and customization during prediction of attention score. In another implementation one or more alternative data processing techniques, one or more machine learning techniques, or statistical methods may be employed by the processing unit [104] to derive attention scores or to refine a prediction of user attention levels based on the sensor data. For example, in an implementation the use of a Hidden Markov Technique may be replaced with a Recurrent Neural Network based approach to predict the attention score.

Additionally, in an implementation, a sensor data may be combined with other metrics or data sources to enhance an accuracy and comprehensiveness of measurement of attention score. For example, data from light sensors, or biometric sensors (e.g., heart rate monitors) may be incorporated to further refine an assessment of user attention or to capture additional contextual information. These structural alternatives allow for customization, adaptation, and optimization of device sensor-based method for measuring user attention in in-app content delivery. By exploring these alternatives, the present disclosure may be tailored to specific platforms, devices, or industry requirements, ensuring its versatility and practicality in various real-world scenarios.

Thereafter, once the attention score for the user is predicted, the categorization unit [106] connected to the processing unit [104] is configured to categorize the attention score in an attention category based on a pre-defined attention threshold. The pre-defined attention threshold may be a pre-defined score related to one or more attention categories to categorize the attention score in a particular attention category. The attention category is one of a very high attention category, a high attention category, a medium attention category, a low attention category, and a very low attention category. In an example if a pre-defined attention threshold related to high attention category is 10, a pre-defined attention threshold related to very high attention category is 15 and the predicted the attention score is 11, then the attention score is categorized in the high attention category based on the pre-defined attention threshold related to the high attention category. It is pertinent to note that this example is not limiting and only for illustrative purposes, and any manner that is obvious to a person skilled in the art to categorize the attention score in light of the present disclosure may be considered to implement the features of the present disclosure.

Furthermore, the very high attention category indicates that in light of the sensor data there is a very high probability of the user paying attention to the content. The high attention category indicates that in light of the sensor data there is a high probability of the user paying attention to the content. The medium attention category indicates a requirement of a data additional to the sensor data to determine a specific probability of the user paying attention to the content. The low attention category indicates that in light of the sensor data there is a lower probability of the user paying attention to the content. The very low attention category indicates that in light of the sensor data there is a very low probability of the user paying attention to the content, such as when the user device is upside down on a table or kept in a pocket etc.

Moreover, while the present disclosure discloses five types of categories (very high attention category, high attention category, medium attention category, low attention category, and very low attention category) i.e., a five-level attention scoring system (very high, high, medium, low, very low), however the present disclosure is not limited thereto. In an implementation, alternative scoring schemes or categorization methods may be implemented based on specific needs of a target audience or content providers such as advertiser. Also, in an implementation, the number or types of attention categories, a criterion for assigning attention scores to corresponding attention categories, or a use of additional metadata may be adjusted to provide more nuanced insights into user attention.

The processing unit [104] is then configured to initiate an action based on the attention category. For e.g., an action may be delivering a specific content such as a specific advertisement on the user device based on the attention category, or in another e.g., an action may be providing a notification or recommendation of a specific content such as a specific media stream on the user device based on the attention category. Moreover, in an event where an action is to deliver a specific content say a specific advertisement on a user device, based on the implementation of features of present disclosure, advertiser(s) may decide on which inventory to target for delivering the specific advertisement depending on an attention score or on an attention category. Additionally, in such event attention score(s) or attention category(ies) as determined based on the implementation of features of the present disclosure may be used to fine-tune content targeting strategies. In an instance, the advertiser(s) may adjust content targeting parameter(s) based on demographics and behaviors of user(s) who show higher attention levels, ensuring advertisements reach the most receptive audience. Therefore, the attention score(s) or attention category(ies) may guide content provider(s) say advertiser(s) in creating content that resonates with target audience. For example, understanding which elements of an advertisement capture users' attention allows advertisers to tailor their creative assets to better engage users and deliver more relevant experiences.

Furthermore, in an exemplary implementation, the action may be a campaign optimization action. Particularly, real-time prediction of the attention score as disclosed in the present disclosure, may enable content providers say advertisers to make informed decisions during live campaigns. For instance, if an attention score indicates a lower engagement, the advertisers may adjust campaign elements such as creative, messaging, or placements to improve performance on-the-go.

It is pertinent to note that although certain examples of action are disclosed in the present disclosure, however the present disclosure is not limited thereto, and an action may include any action that may be obvious to a person skilled in the art in light of the present disclosure.

Therefore, by leveraging the power of user device's sensors and analyzing the captured sensor data, the solution as disclosed herein provides a practical and scalable solution for predicting the user's attention while delivering the content on the user device such as during an in-app advertising etc. The attention score generated may assist content providers such as advertisers in assessing the effectiveness of their campaigns and making data-driven decisions to optimize content or Ad placements and user engagement etc.

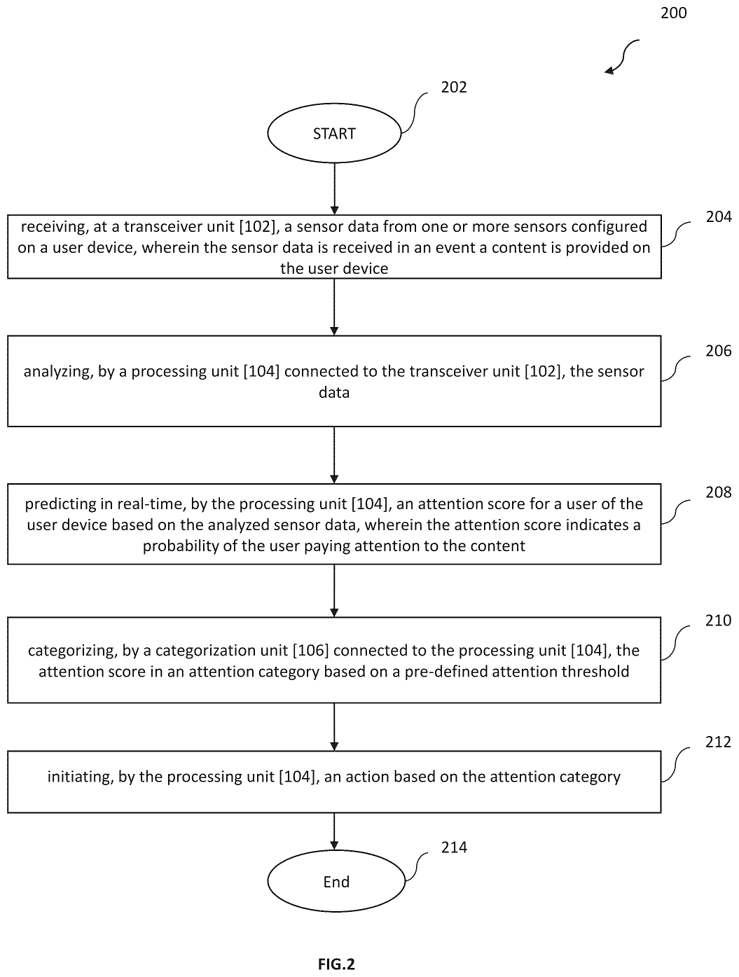

Referring to FIG. 2 that illustrates an exemplary method flow diagram [200], for initiating an action based on an attention category, in accordance with exemplary embodiments of the present disclosure. In an implementation the method [200] is performed by the system [200]. Also, as shown in FIG. 2, the method [200] starts at step [202].

Next at step [204] the method encompasses receiving, at a transceiver unit [102], a sensor data from one or more sensors configured on a user device, wherein the sensor data is received in an event a content is provided on the user device. Also, in an implementation of the present disclosure the sensor data is received in accordance with one or more pre-defined permissions of data collection and the sensor data is a data that may be correlated with an attention of a user of the user device with the content provided on the user device.

The content is one of an advertisement related media content and a non-advertisement related media content. In a preferred implementation of the present disclosure the content is the advertisement related media content, however the disclosure is not limited thereto, and the features of the present disclosure may also be implemented for non-advertisement related media content for instance at least to predict a user engagement with such non-advertisement related media content.

Further, the one or more sensors may include but not limited to at least one of an accelerometer, a gyroscope, a proximity sensor, an orientation sensor, and an audio control integration sensor etc. Also, the sensor data comprises at least one of an accelerometer sensor data, a gyroscope sensor data, a proximity sensor data, an orientation sensor data, an integration sensor data, and the like data. The accelerometer sensor data is received from the accelerometer, wherein the accelerometer sensor data indicates one or more changes in at least one of a movement of the user device and an acceleration of the user device. The gyroscope sensor data is received from the gyroscope, wherein the gyroscope sensor data indicates one or more changes in at least one of an orientation of the user device and an angular speed of the user device. The proximity sensor data is received from the proximity sensor, wherein the proximity sensor data indicates one or more changes in a distance of the user device from one or more objects (such as for e.g., face of the user etc.). The orientation sensor data is received from the orientation sensor, wherein the orientation sensor data indicates one or more changes in at least one of an orientation of the user device and a direction of the user device. Also, the integration sensor data is received from the audio control integration sensor, wherein the integration sensor data indicates one or more changes in an audio level of the user device. The sensor data helps in considering various scenarios related to the user device, such as including but not limited to user device orientation, user device movement, proximity changes, and audio level adjustments, to provide a comprehensive assessment of user attention for the content.

It is pertinent to note that in the present disclosure although specific details of sensors and sensor data are disclosed, however for implementation of present solution sensor configuration and sensor integration are not limited or restricted in any manner. Any sensor configuration and any sensor integration that may be obvious to a person skilled in the art in light of the present disclosure may be implemented to provide the solution as disclosed in the present disclosure. Mainly, specific types and configurations of sensors utilized in the present disclosure may be altered based on a desired use-case, application, or platform. For example, alternative motion sensors, orientation sensors, proximity sensors, or audio sensors etc., may be used depending on capabilities of various devices or specific attention parameters to be measured. In an implementation, the number of sensors and arrangement of the sensors may also be modified to suit different devices or to optimize data collection. Moreover, the way in which the sensors are integrated into an in-app environment may be adapted to accommodate various user interfaces and operating systems. In an implementation different methods of sensor integration, such as including but not limiting to software development kits (SDKs), application programming interfaces (APIs), or platform-specific frameworks, may be employed to ensure seamless integration and compatibility of the sensors.

Further, once the sensor data is received, next at step [206] the method comprises analyzing, by a processing unit [104] connected to the transceiver unit [102], the sensor data. The sensor data is analyzed by the processing unit [104] using one or more data analysis techniques that may be obvious to a person skilled in the art for implementation of the features of the present disclosure. Also, in an implementation the processing unit [104] also pre-processes the sensor data using one or more data processing techniques that may be obvious to a person skilled in the art for implementation of the features of the present disclosure. The sensor data may be pre-processed prior to analyzing, in order to remove any ambiguity and/or to convert the sensor data in a required format. Also, in an exemplary implementation during the analysis of the sensor data a weightage may be provided to at least one of the accelerometer sensor data, the gyroscope sensor data, the proximity sensor data, the orientation sensor data, the integration sensor data, and the like data, wherein such weightage may be provided basis a particular use case and may vary in different use cases, for example when a user is holding a user device and watching a content on the user device while walking, more weightage to motion sensor data may be provided as compared to other sensor data, however the disclosure is not limited thereto.

Next at step [208] the method encompasses predicting in real-time, by the processing unit [104], an attention score for a user of the user device based on the analyzed sensor data, wherein the attention score indicates a probability of the user paying attention to the content. Particularly, the attention score indicates a probability of the user paying attention in real-time to one of the advertisement related media content and the non-advertisement related media content. Also, in the preferred implementation of the present disclosure, the attention score indicates the probability of the user paying attention to the advertisement related media content.

Also, the attention score for the user is predicted by the processing unit [104] using one or more temporal probabilistic techniques. In an implementation, a temporal probabilistic technique is a Hidden Markov Technique (HMT) that provides an approach to include the sequence of prior observations (e.g., motion sensor measurements), in the process of inferring a hidden state—i.e., user's attention state (the user's attention is not directly observable).

The HMT (λ) uses three sets of probabilities, the starting state (π), the probability of transitioning from one state to another (A) and the probability of an observation (data measurement) occurring in an Attention State (B).

λ=(A,B,π)

The State Alphabet is:

S=(S_{Full attention},S_{High Attention},S_{Medium Attention},S_{Low Attention},S_{N}_{ₒ}ₐₜₜₑₙₜᵢₒₙ)

The State Alphabet may be extended to support a richer set of attention states. A is the probability of transitioning from one attention state to another (transition matrix). B is the observation matrix that captures the probability of a set of measurements V(1, 2, . . . , v) occurring in a given Attention State. Measurements from the sensors (i.e., sensor data) are mapped to a discrete set of observations. For example, an orientation of the user device as indicated by combining sensor data received from the accelerometer and gyroscope. Also, a tremble data (e.g., from the motion sensors) may be processed to represent different states of tremble (motionless Vs slight tremble Vs significant tremble). Using this set of observations V, the probability may be calculated that they occurred in the HMT using the Forward-Backward Technique. This allows to determine an Attention Score/State. In an implementation a previously predicted attention score may be used as feedback to determine an attention score in a particular use case.

In an implementation of the present disclosure, specific techniques and methodologies used for processing and analysing the sensor data may be varied to enhance accuracy and customization during prediction of attention score. In another implementation one or more alternative data processing techniques, one or more machine learning techniques, or statistical methods may be employed by the processing unit [104] to derive attention scores or to refine a prediction of user attention levels based on the sensor data. For example, in an implementation the use of a Hidden Markov Technique may be replaced with a Recurrent Neural Network based approach to predict the attention score.

Additionally, in an implementation, a sensor data may be combined with other metrics or data sources to enhance an accuracy and comprehensiveness of measurement of attention score. For example, data from light sensors, or biometric sensors (e.g., heart rate monitors) may be incorporated to further refine an assessment of user attention or to capture additional contextual information. These structural alternatives allow for customization, adaptation, and optimization of device sensor-based method for measuring user attention in in-app content delivery. By exploring these alternatives, the present disclosure may be tailored to specific platforms, devices, or industry requirements, ensuring its versatility and practicality in various real-world scenarios.

Further, once the attention score for the user is predicted, next at step [210] the method comprises categorizing, by a categorization unit [106] connected to the processing unit [104], the attention score in an attention category based on a pre-defined attention threshold. The pre-defined attention threshold may be a pre-defined score related to one or more attention categories to categorize the attention score in a particular attention category. The attention category is one of a very high attention category, a high attention category, a medium attention category, a low attention category, and a very low attention category. In an example if a pre-defined attention threshold related to low attention category is 5, a pre-defined attention threshold related to very low attention category is 1 and the predicted the attention score is 4, then the attention score is categorized in the low attention category based on the pre-defined attention threshold related to the low attention category. It is pertinent to note that this example is not limiting and only for illustrative purposes, and any manner that is obvious to a person skilled in the art to categorize the attention score in light of the present disclosure may be considered to implement the features of the present disclosure.

Furthermore, the very high attention category indicates that in light of the sensor data there is a very high probability of the user paying attention to the content. The high attention category indicates that in light of the sensor data there is a high probability of the user paying attention to the content. The medium attention category indicates a requirement of a data additional to the sensor data to determine a specific probability of the user paying attention to the content. The low attention category indicates that in light of the sensor data there is a lower probability of the user paying attention to the content. The very low attention category indicates that in light of the sensor data there is a very low probability of the user paying attention to the content, such as when the user device is upside down on a table or kept in a pocket etc.

Moreover, while the present disclosure discloses five types of categories (very high attention category, high attention category, medium attention category, low attention category, and very low attention category) i.e., a five-level attention scoring system (very high, high, medium, low, very low), however the present disclosure is not limited thereto. In an implementation, alternative scoring schemes or categorization methods may be implemented based on specific needs of a target audience or content providers such as advertiser. Also, in an implementation, the number or types of attention categories, a criterion for assigning attention scores to corresponding attention categories, or a use of additional metadata may be adjusted to provide more nuanced insights into user attention.

Next at step [212] the method comprises initiating, by the processing unit [104], an action based on the attention category. For e.g., an action may be delivering a specific content such as a specific advertisement on the user device based on the attention category, or in another e.g., an action may be providing a notification or recommendation of a specific content such as a specific media stream on the user device based on the attention category. Moreover, in an event where an action is to deliver a specific content say a specific advertisement on a user device, based on the implementation of features of present disclosure, advertiser(s) may decide on which inventory to target for delivering the specific advertisement depending on an attention score or on an attention category. Additionally, in such event attention score(s) or attention category(ies) as determined based on the implementation of features of the present disclosure may be used to fine-tune content targeting strategies. In an instance, the advertiser(s) may adjust content targeting parameter(s) based on demographics and behaviors of user(s) who show higher attention levels, ensuring advertisements reach the most receptive audience. Therefore, the attention score(s) or attention category(ies) may guide content provider(s) say advertiser(s) in creating content that resonates with target audience. For example, understanding which elements of an advertisement capture users' attention allows advertisers to tailor their creative assets to better engage users and deliver more relevant experiences.

Furthermore, in an exemplary implementation, the action may be a campaign optimization action. Particularly, real-time prediction of the attention score as disclosed in the present disclosure, may enable content providers say advertisers to make informed decisions during live campaigns. For instance, if an attention score indicates a lower engagement, the advertisers may adjust campaign elements such as creative, messaging, or placements to improve performance on-the-go.

The method then terminates as step [214].

Some examples based on the solution disclosed herein are as below:

### Example 1: An Application (App) Displayed on a User Device Lying on a Desk

Scenario: A user is sitting at a desk with the user device lying on the desk.
Result as per the solution: Detection of the stable orientation and absence of significant movement of the user device, concluding that the user's attention is high, thereby categorising attention score in high attention category and initiating an action (e.g., displaying an Ad) on the user device accordingly.

### Example 2: User Interaction with a Video Ad

Scenario: The user interacts with a video Ad provided on a user device by decreasing the volume gradually from a specific level to 0.
Result as per the solution: Detection of a change in audio level of the user device and classification of the attention as low due to the decreasing volume during the Ad, thereby initiating an action (e.g., stop displaying an Ad) on the user device accordingly.

### Example 3: User's Phone Orientation

Scenario: The user is holding the phone in portrait mode with the phone's roll angle within the range of −45 to 45 degrees.
Result as per the solution: Detection of the stable phone orientation and determining that the user's attention is high. As user moves the phone in opposite orientation, value of attention changes to low, and thereby initiating an action on the phone accordingly.

The above stated examples illustrate how the solution as disclosed herein uses a device sensor data and performs multilevel checks to predict user attention accurately. By providing insights into user engagement during in-app content delivery such as in-app advertising, the solution empowers content providers such as advertisers to optimize their campaigns and enhance the effectiveness of their content or Ads.

The present disclosure brings notable technical effects and advancements to the field of data processing and predicting user engagement. Particularly, the present disclosure provides a solution that incorporates a combination of sensors, including accelerometer, gyroscope, proximity sensor, orientation/rotation vector sensor, and/or audio control sensor etc., to capture a comprehensive range of data for attention assessment. This approach is technically advanced over the existing approaches as it leverages multiple sensors to provide a more accurate prediction of user attention. Also, the attention score generated by the solution as disclosed herein introduces a technical advanced classification system that categorizes attention levels of user(s) into different tiers. This scoring framework allows for a more nuanced understanding of user attention based on the collected sensor data. Additionally, the solution as disclosed herein employs multilevel checks to evaluate user attention. It considers various scenarios related to the user device, such as user device orientation, user device movement, proximity changes, and audio level adjustments, to provide a comprehensive assessment of attention. Moreover, the present solution is technically advanced over the existing solutions as it encompasses use of sensors configured on the user device to 1) enable real-time monitoring of user attention to a media content displayed on the user device, and 2) reduce cost by eliminating a need for expensive equipment and extensive recruitment efforts associated with panel-based approaches for real-time monitoring of the user attention to the media content. Additionally, the present solution may be implemented within various in-application (i.e., in-app) environments installed in various devices compatible with different operating systems, covering a wide range of applications and industries. Therefore, the solution as disclosed herein has several technical advantages over the existing solutions.

While considerable emphasis has been placed herein on the preferred embodiments, it will be appreciated that many embodiments can be made and that many changes can be made in the preferred embodiments without departing from the principles of the disclosure. These and other changes in the preferred embodiments of the disclosure will be apparent to those skilled in the art from the disclosure herein, whereby it is to be distinctly understood that the foregoing descriptive matter to be implemented merely as illustrative of the disclosure and not as limitation.

What is claimed is:

1. A method of initiating an action based on an attention category, the method comprises:
receiving, at a transceiver unit [102], a sensor data from one or more sensors configured on a user device, wherein the sensor data is received in an event a content is provided on the user device;
analyzing, by a processing unit [104] connected to the transceiver unit [102], the sensor data;
predicting in real-time, by the processing unit [104], an attention score for a user of the user device based on the analyzed sensor data, wherein the attention score indicates a probability of the user paying attention to the content;
categorizing, by a categorization unit [106] connected to the processing unit [104], the attention score in an attention category based on a pre-defined attention threshold; and
initiating, by the processing unit [104], an action based on the attention category.

2. The method as claimed in claim 1, wherein the one or more sensors comprise at least one of an accelerometer, a gyroscope, a proximity sensor, an orientation sensor, and an audio control integration sensor.

3. The method as claimed in claim 2, wherein the sensor data comprises at least one of:
an accelerometer sensor data received from the accelerometer, wherein the accelerometer sensor data indicates one or more changes in at least one of a movement of the user device and an acceleration of the user device,
a gyroscope sensor data received from the gyroscope, wherein the gyroscope sensor data indicates one or more changes in at least one of an orientation of the user device and an angular speed of the user device,
a proximity sensor data received from the proximity sensor, wherein the proximity sensor data indicates one or more changes in a distance of the user device from one or more objects,
an orientation sensor data received from the orientation sensor, wherein the orientation sensor data indicates one or more changes in at least one of an orientation of the user device and a direction of the user device, and
an integration sensor data received from the audio control integration sensor, wherein the integration sensor data indicates one or more changes in an audio level of the user device.

4. The method as claimed in claim 1, wherein the content is one of an advertisement related media content and a non-advertisement related media content.

5. The method as claimed in claim 1, wherein the sensor data is analyzed by the processing unit [104] using one or more data analysis techniques.

6. The method as claimed in claim 1, wherein the attention score for the user is predicted by the processing unit [104] using one or more temporal probabilistic techniques.

7. The method as claimed in claim 1, wherein the attention category is one of a very high attention category, a high attention category, a medium attention category, a low attention category, and a very low attention category.

8. The method as claimed in claim 7, wherein:
the very high attention category indicates a very high probability of the user paying attention to the content,
the high attention category indicates a high probability of the user paying attention to the content,
the medium attention category indicates a requirement of a data additional to the sensor data to determine a specific probability of the user paying attention to the content,
the low attention category indicates a lower probability of the user paying attention to the content, and
the very low attention category indicates a very low probability of the user paying attention to the content.

9. A system of initiating an action based on an attention category, the system comprises:
a transceiver unit [102], configured to receive, a sensor data from one or more sensors configured on a user device, wherein the sensor data is received in an event a content is provided on the user device;
a processing unit [104] connected to the transceiver unit [102], wherein the processing unit [104] is configured to:
analyze, the sensor data, and
predict in real-time, an attention score for a user of the user device based on the analyzed sensor data, wherein the attention score indicates a probability of the user paying attention to the content; and
a categorization unit [106] connected to the processing unit [104], wherein the categorization unit [106] is configured to categorize the attention score in an attention category based on a pre-defined attention threshold, and wherein:
the processing unit [104] is further configured to initiate an action based on the attention category.

10. The system as claimed in claim 9, wherein the one or more sensors comprise at least one of an accelerometer, a gyroscope, a proximity sensor, an orientation sensor, and an audio control integration sensor.

11. The system as claimed in claim 10, wherein the sensor data comprises at least one of:
an accelerometer sensor data received from the accelerometer, wherein the accelerometer sensor data indicates one or more changes in at least one of a movement of the user device and an acceleration of the user device,
a gyroscope sensor data received from the gyroscope, wherein the gyroscope sensor data indicates one or more changes in at least one of an orientation of the user device and an angular speed of the user device,
a proximity sensor data received from the proximity sensor, wherein the proximity sensor data indicates one or more changes in a distance of the user device from one or more objects,
an orientation sensor data received from the orientation sensor, wherein the orientation sensor data indicates one or more changes in at least one of an orientation of the user device and a direction of the user device, and
an integration sensor data received from the audio control integration sensor, wherein the integration sensor data indicates one or more changes in an audio level of the user device.

12. The system as claimed in claim 9, wherein the content is one of an advertisement related media content and a non-advertisement related media content.

13. The system as claimed in claim 9, wherein the sensor data is analyzed by the processing unit [104] using one or more data analysis techniques.

14. The system as claimed in claim 9, wherein the attention score for the user is predicted by the processing unit [104] using one or more temporal probabilistic techniques.

15. The system as claimed in claim 9, wherein the attention category is one of a very high attention category, a high attention category, a medium attention category, a low attention category, and a very low attention category.

16. The system as claimed in claim 15, wherein:
the very high attention category indicates a very high probability of the user paying attention to the content,
the high attention category indicates a high probability of the user paying attention to the content,
the medium attention category indicates a requirement of a data additional to the sensor data to determine a specific probability of the user paying attention to the content,
the low attention category indicates a lower probability of the user paying attention to the content, and
the very low attention category indicates a very low probability of the user paying attention to the content.
